(19) United States
(12) Patent Application Publication
(10) Pub. No.: US 2022/0061311 A1
(43) Pub. Date: Mar. 3, 2022

(54) COMPOSITIONS AND METHODS FOR REDUCING CRYOPRESERVATION TOXICITY

(71) Applicant: The Regents of the University of Colorado, a body, Denver, CO (US)

(72) Inventors: Thomas E. Johnson, Louisville, CO (US); James R. Cypser, Westminster, CO (US); Wallace S. Chick, Centennial, CO (US); Garrett J. Schumacher, Sterling, CO (US)

(73) Assignee: The Regents of the University of Colorado, a body corporate, Denver, CO (US)

(21) Appl. No.: 17/291,204

(22) PCT Filed: Nov. 4, 2019
(86) PCT No.: PCT/US2019/059733

§ 371 Date: May 4, 2021

Related U.S. Application Data
(60) Provisional application No. 62/755,892, filed on Nov. 5, 2018.

(51) Int. Cl. A01N 1/02

(52) U.S. Cl. CPC A01N 1/0221

(57) ABSTRACT

Compositions and methods for reducing the toxic effects of cryopreservation in living materials undergoing standard cryopreservation procedures. In embodiments of the present invention such methods including blocking or reducing the function of the Gm14005, Nrg2/Pura, Fgd2/Pim1, Opa1/Hes1, Myh9, and Hsbp1/Ywhag genes, their gene products, or their downstream effectors. In embodiments, cells, tissues, organs, or organisms are treated with Afatinib, Staurosporine, UCN-01, Quercetagetin, LY294002, Quercetin, Adenosine monophosphate, Blebbistatin, or Agalloside prior to, during, or after the cryopreservation process to reduce cryopreservation toxicity.

### CROSS-REFERENCE TO RELATED APPLICATIONS

This application claims the benefit of U.S. Provisional Application No. 62/755,892, filed Nov. 5, 2018.

### STATEMENT OF GOVERNMENT INTEREST

This invention was made with government support under grant number AG041801 awarded by the National Institutes of Health. The government has certain rights in the invention.

### FIELD OF INVENTION

This invention relates to the cryopreservation of biological material, including living cells, tissues, and organs, particularly those of vertebrates, especially humans.

### BACKGROUND OF THE INVENTION

On average in the United States, 20 people die every day while awaiting an organ transplant, and up to a third of all deaths in the United States could be prevented by organ transplantation. A lack of viable donor organs is one key reason for this sad state of affairs. One way to increase the number of donor organs would be to improve the ability of medical professionals to preserve potential donor organs, allowing the organs to be transferred longer distances to reach a potential recipient, as well as extending the amount of time a donor organ can be stored prior to transplantation.

Reducing temperature, and in particular freezing, has long been recognized as one of the most effect preservation techniques known to man. However, when aqueous material, such as a living tissue, is frozen, the formation of ice crystals will typically result in severe damage to the material. In the case of living tissues, such as mammalian organs, the formation of ice crystals during freezing will result in the death of the tissue unless appropriate measures are taken to prevent such crystallization.

Cryopreservation via vitrification (formation of a glassy intracellular and extracellular state) enables ice crystallization to be avoided even in whole organs that are cooled to cryogenic temperatures, thus allowing for indefinite storage of viable cells, tissues, and whole organs. However, all currently available vitrification solutions possess an unacceptably high level of toxicity. This cryopreservation toxicity (CT) is the major barrier to medically adequate organ banking. As such, there is a large and pressing need for a method of reducing the cryopreservation toxicity associated with standard cryopreservation techniques.

### SUMMARY OF THE INVENTION

The long-standing but heretofore unfulfilled need for is now met by a new, useful, and nonobvious invention, which result in a significant reduction in the cryopreservation toxicity (CT) associated with standard cryopreservation techniques.

Thus, it is one aspect of the present invention to provide an effective amount of a cryopreservation toxicity reducing agent to a cell, tissue, or organ at risk of suffering damage from the cryopreservation process. In certain embodiments of the present invention, the CT reducing agent may be Afatinib, Staurosporine, UCN-01, or a combination of some or all of the three drugs. Other agents may also be discovered.

It is an aspect of certain embodiments of the present invention to provide a CT reducing agent that inhibits the action of genes or gene products that reduce CT resistance, or that act upon targets downstream of such genes. In certain embodiments, said genes comprise Gm14005, Nrg2/Pura, Fdg2/Pim1, Opa1/Hes1, Myh9, and Hsbp1/Ywhag.

Thus, it is one embodiment of the present invention to provide a method for reducing cryopreservation toxicity (CT) in living cells, the method comprising: identifying cells at risk of CT; and administering to said cells an effective amount of a CT reducing agent.

It is another embodiment of the present invention to provide such a method, wherein said cells at risk of CT are aggregated into a tissue.

It is still another embodiment of the present invention to provide such a method, wherein said tissue is an organ comprised of at least one cell type.

It is yet another embodiment of the present invention to provide such a method, where said CT reducing agent is selected from a group comprising at least one of Afatinib, Staurosporine, and UCN-01.

It is yet another embodiment of the present invention to provide such a method, where said CT reducing agent is selected from a group comprising at least one of Afatinib, Gilotrif, Staurosporine, UCN-01, Quercetagetin, LY294002, Quercetin, Adenosine monophosphate, Blebbistatin, and Agalloside.

It is yet another embodiment of the present invention to provide such a method, where said CT reducing agent is selected from a group comprising at least one of Afatinib/Gilotrif, Quercetagetin, LY294002, Quercetin, Adenosine monophosphate (Adenosine 5-monophosphate monohydrate), Staurosporine, 3,4-Dihydroxy-1-Methylquinolin-2(1h)-One, 2-(4-Morpholinyl)-8-Phenyl-4h-1-Benzopyran-4-One, (3 e)-3-[(4-Hydroxyphenyl)Imino]-1h-Indol-2(3h)-One, Rbt205 Inhibitor, Phosphoaminophosphonic Acid-Adenylate Ester, Phosphonoserine, S, S-(2-Hydroxyethyl)Thiocysteine, IMIDAZOPYRIDAZIN 1,4-(4-hydroxy-3-methylphenyl)-6-phenylpyrimidin-2(5H)-one, N-phenyl-1H-pyrrolo[2,3-b]pyridin-3-amine, (2S)-1,3-benzothiazol-2-yl{2-[(2-pyridin-3-ylethyl)amino]pyrimidin-4-yl}ethanenitrile, (4R)-7,8-dichloro-1′,9-dimethyl-1-oxo-1,2,4, 9-tetrahydrospiro[beta-carboline-3,4′-piperidine]-4-carbonitrile, (4R)-7-chloro-9-methyl-1-oxo-1,2,4,9-tetrahydrospiro[beta-carboline-3,4′-piperidine]-4-carbonitrile, 5, 7-DIHYDROXY-2-(3,4,5-TRIHYDROXYPHENYL)-4H-CHROMEN-4-ONE, 6-(5-BROMO-2-HYDROXYPHENYL)-2-OXO-4-PHENYL-1,2-DIHYDROPYRIDINE-3-CARBONITRILE, 4-[3-(4-chlorophenyl)-2,1-benzisoxazol-5-yl]pyrimidin-2-amine, N-cyclohexyl-3-[3-(trifluoromethyl)phenyl] [1,2,4]triazolo[4,3-b]pyridazin-6-amine, 2,3-diphenyl-1H-indole-7-carboxylic acid, Blebbistatin, and Agalloside.

It is yet another embodiment of the present invention to provide such a method, where said CT reducing agent is selected from a group comprising at least one of the drugs listed in Table 5, below.

It is still another embodiment of the present invention to provide such a method, wherein said CT reducing agent is administered prior to the cryopreservation of the cells.

It is yet another embodiment of the present invention to provide such a method, wherein said CT reducing agent is administered during the cryopreservation process.

It is still another embodiment of the present invention to provide such a method, wherein said CT reducing agent is administered after the cells have underwent the cryopreservation process.

These, and other, embodiments of the invention will be better appreciated and understood when considered in conjunction with the following description and the accompanying tables. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

For a fuller understanding of the invention, reference should be made to the following detailed description, taken in connection with the accompanying drawings, in which:

FIG. 1 is a histogram depicting the increased survival of cells treated with Afatinib prior to cryopreservative toxicity challenge with M22.

FIG. 2 is a set of four graphs. Sterile young adult worms from TJ1060 were put into liquid survival medium on day 3 (eggs=day 0) with increasing concentrations of M22 and followed until all were dead. A. Experiment one=0, 1, 5, 10% M22. B. Experiment two=0, 5, 10, 20% M22. All concentrations of M22 significantly shortened lifespan, *=p<0.05, §=p<0.0001.

FIG. 3 is a histogram. To assess fertility, one L4/young adult N2 worm was placed on an NGM agar plate with varying concentrations of M22 at 20° C. Worms were transferred each day to new plates. Counts were made of the total progeny (4 experiments shown) for each concentration of M22. All concentrations of M22 reduce the average total fertility.

FIG. 4 is a histogram. Maximum development on M22 was followed. One L4/young adult worm was placed on an NGM agar plate with varying concentrations of M22 at 20° C. Maximum development of progeny was recorded daily: 1=egg, 2=L1, 3=L2, 4=L3, 5=L4, 6=adult. Day 1 is the first day of parental adulthood. In this experiment, no change was seen after day 11. Three replicate experiments were performed with similar results.

FIG. 5 is a histogram. Fertile young adult worms were put into liquid survival medium with 10% M22 and followed until death. A wild-type control, N2, and mutants from the ILS pathway were compared. Shown is the average mean survival of 3-4 blinded experiments per strain, †=p<0.01, §=p<0.0001. Values for all experiments are shown in Table 1.

FIG. 6 is a histogram. Sterile young adult worms (TJ1060) were put into liquid survival medium with 10% M22 and varying concentrations of Afatinib and followed until all were dead. Data from 4 replicate blinded experiments are shown. Afatinib at 100 nM was significantly better than control of no afatinib, ‡=p<0.001. Values for all experiments are shown in Table 2.

FIG. 7 is a set of nine graphs labeled A-H. In mutant M2.2, expression of the gene Nrg2 is downregulated. This is important because loss of function of Nrg2 is expected to have the same effect as application of afatinib. A-D=Amplification Plot (Rn vs. Cycle); E is a histogram showing a Gene Expression Plot (RQ vs Sample); F-I are standard curves for Pura (F), Myh9 (G), Hprt (H) and Nrg2 (I).

### DETAILED DESCRIPTION OF THE PREFERRED EMBODIMENT

Cryopreservation by freezing results in unacceptable damage to aqueous materials due to the formation of ice crystals during the freezing process. Therefore, it is necessary to reduce ice formation as much as possible.

One way to reduce ice formation is by using a sufficient concentration of cryoprotective agent or agents. Fahy has proposed, in fact, that all ice formation should be prevented by enabling vitrification, or the conversion of the liquid state to a glassy, non-crystalline state upon cooling. (Fahy et al., Vitrification as an approach to cryopreservation, (1984) Cryobiology 21:4, 407-426). This approach is promising, as indicated by the permanent survival of a vitrified rabbit kidney after transplantation (Fahy et al., Physical and biological aspects of renal vitrification (2009) Organogenesis 5:3, 167-175). Unfortunately, in order to achieve vitrification, high concentrations of cryoprotectants (on the order of 50-70% w/v) must be used, and may be much more toxic than the concentrations normally used for freezing cell suspensions (˜10% v/v). This fact remains true despite elimination of osmotic damage from cryoprotectants and much research on the formulation of minimum-toxicity mixtures of cryoprotectants for vitrification.

Cryoprotective agents, or cryoprotectants, have been known in the art for some time. Standard cryoprotectants include, by way of example and not limitation, glycerol, DMSO, dextrans, glycols, starches, sugars, and polyvinylpyrrolidones. These agents may be used either alone or in combination. Such combinations include B2C, which comprises on a weight to volume basis 24.765% DMSO, 17.836% formaldahyde, 17.401% Ethylene glycol, 2% Polyvinyl pyrrolidone K12, 2% Polyvinyl pyrrolidone

K30, and 1% each of ice blockers X-1000 and Z-1000; and M22, which comprises 22.305% DMSO, 12.858% Formaldehyde, 16.837% Ethylene glycol, 3% N-methylformamide, 4% 3-methoxy-1,2-propanediol, 2.8% Polyvinyl pyrrolidone K12, 1% ice blocker X-1000, and 2% ice blocker Z-1000. Both M22 and B2C also comprise a suitable carrier solution.

### EXAMPLE 1

### Identification of Genes that Impede Cryopreservation Resistance

In order to identify any genes which may reduce the ability of a living cell to withstand CT, a library of transposon-mutagenized mouse ES cells were subjected to lethal selection by 7-day incubation in 9% M22 in normal culture media at 37° C. Over 12,000 separate cell lines were subjected to this treatment, and the overwhelming majority of them failed to survive. Of those that survived, only those cell lines that displayed enhanced resistance upon re-exposure to M22 were kept.

To further validate that the cell lines displayed enhanced CT resistance, the cell lines were then challenged by exposure to the most popular freezing method (10% dimethyl sulfoxide followed by freezing at −80° C.), the post-thaw survival of the mutants was up to four times higher than for unmodified ESCs. From this initial selection, we identified 6 clones that survived treatment with M22.

Table 1 describes the genes that were disrupted by the six mutants. These genes may include Gm14005, Nrg2/Pura, Fgd2/Pim1, Opa1/Hes1, Myh9, and Hsbp1/Ywhag. Gm14005 is an uncharacterized gene most likely expressed only as a long noncoding RNA. The NRG2 protein directly binds the ERBB3/4 receptor tyrosine kinase. The PURA protein is a probable transcription activator that specifically binds the purine-rich single strand of the PUR element located upstream of the c-Myc gene. Fdg2 encodes a guanine nucleotide exchange factor (GEF), which specifically activates Cdc42, thus controlling cytoskeleton-dependent membrane rearrangements. Pim1 is a proto-oncogene with serine/threonine kinase that exerts its oncogenic activity through: the regulation of MYC transcriptional activity, the regulation of cell cycle progression and by phosphorylation and inhibition of proapoptotic proteins. Opa1 encodes a nuclear-encoded mitochondrial protein which localizes to the inner mitochondrial membrane and helps regulate mitochondrial stability and energy output. The HES1 protein may act as a negative regulator of myogenesis by inhibiting the functions of MYOD1 and ASH1. Myh9 encodes a conventional non-muscle myosin, which is involved in several important functions, including cytokinesis, cell motility and maintenance of cell shape. Hsbp 1 encodes a nuclear-localized protein which interacts with the active trimeric state of Heat Shock Factor 1 (HSF1) to negatively regulate HSF1 DNA-binding activity during a “heat-shock” response. YWHAG is an adapter protein implicated in the regulation of many signaling pathways by binding to a phosphoserine or phosphothreonine motif

TABLE 1
Cryo Mutants
Table 1. Cryo mutants

| Clone | Insertion in (or between) |
|---|---|
| M2.1 | Gm14005 (noncoding RNA) |
| M2.2 | Nrg2/Pura |
| M3.1 | Fgd2/Pim1 |
| M4.2 | Opa1/Hes1 |
| M4.3 | Myh9 |
| M5.1 | Hsbp1/Ywhag |

Thus, in certain embodiments of the present invention, CT reduction is achieved by mimicking the loss or reduction of function of the above identified genes in a living cell. Such mimicking may be achieved through actual mutation of or otherwise disrupting the genes in question, through use of chemical agents to inhibit the function of the gene or its gene product, through the use of chemical agents or other methods to interact with targets downstream of the identified genes, or though other methods known in the art.

In certain embodiments of the present invention, the CT reduction may be achieved by administering an exogenous agent to the cell, tissue, organ, or organism in order to reduce or eliminate the effect of CT. Depending on the method of action, such CT reducing agents may be administered prior to cryopreservation, during the cryopreservation process, or post-cryopreservation.

Cryopreservation Toxicity Reducing Agents:

Afatinib is a small molecule which irreversibly binds to and inhibits the ERBB3/4 receptor tyrosine kinase. In certain embodiments of the present invention, treatment with Afatinib mimics the loss of function of the ligand-encoding Nrg2 gene identified in the CT resistance mutant screen. Thus, Afatinib acts as a CT reducing agent. Afatinib is an FDA approved drug for the treatment of non-small cell lung carcinoma, and has the following chemical structure:

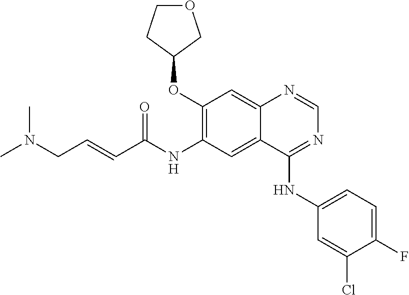 [SMILES: CN(C)C/C=C/C(=O)Nc1cc2c(Nc3ccc(F)c(Cl)c3)ncnc2cc1O[C@H]1CCOC1]

Staurosporine is an ATP-competitive kinase inhibitor that was originally isolated from the bacterium Streptomyces staurosporeus. It has been shown to inhibit the activity of the Pim1 gene product, and as such in certain embodiments of the present invention, Staurosporine acts as a CT reducing agent. Staurosporine has the following chemical structure:

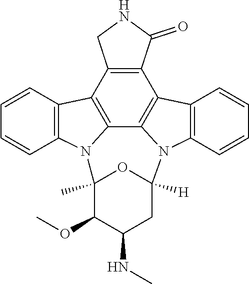 [SMILES: CN[C@@H]1C[C@H]2O[C@@](C)([C@@H]1OC)n1c3ccccc3c3c4c(c5c6ccccc6n2c5c31)C(=O)NC4]

UCN-01 (7-hydroxy Staurosporine) is a chemical derivative of Staurosporine with similar biological activity. As such, in certain embodiments of the present invention, UCN-01 acts as a CT reducing agent. In various embodiments, it does so by inhibiting the activity of the Pim1 gene product. UCN-01 has the following chemical structure:

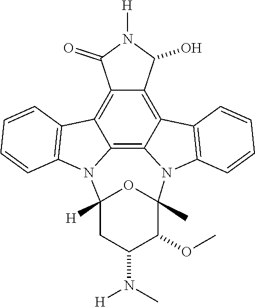 [SMILES: CN[C@@H]1C[C@H]2O[C@@](C)([C@@H]1OC)n1c3ccccc3c3c4c(c5c6ccccc6n2c5c31)C(=O)N[C@@H]4O]

Blebbistatin is an inhibitor of ATPase activity of non-muscle myosin II. It is a pyrroloquinoline, a cyclic ketone, a tertiary alcohol and a tertiary alpha-hydroxy ketone. Blebbistatin is a myosin inhibitor mostly specific for myosin II. It can be used to inhibit heart muscle myosin, non-muscle myosin II, and skeletal muscle myosin. It has been shown to inhibit the activity of the Myh9 gene product, and as such in certain embodiments of the present invention, Blebbistatin acts as a CT reducing agent. Blebbistatin has the following chemical structure:

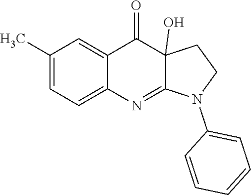 [SMILES: Cc1ccc2c(c1)C(=O)C1(O)CCN(c3ccccc3)C1=N2]

Agalloside is a neural stem cell differentiation activator isolated from Aquilaria agallocha. It has been shown to inhibit the activity of the Hsbp1 gene product, and as such in certain embodiments of the present invention, Agalloside acts as a CT reducing agent.

Quercetagetin is a flavonol that inhibits Pim-1. As such, in certain embodiments of the present invention, Quercetagetin acts as a CT reducing agent. In various embodiments, it does so by inhibiting the activity of the Pim1 gene product. Quercetagetin has the following chemical structure:

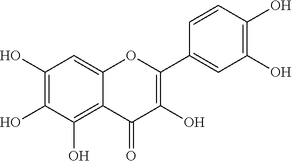 [SMILES: O=c1c(O)c(-c2ccc(O)c(O)c2)oc2cc(O)c(O)c(O)c12]

LY294002 is a morpholine-containing chemical compound that is a potent inhibitor of numerous proteins, and a strong inhibitor of phosphoinositide 3-kinases (PI3Ks). It has been shown to inhibit the activity of the Pim1 gene product, and as such in certain embodiments of the present invention, LY294002 acts as a CT reducing agent. LY294002 has the following chemical structure:

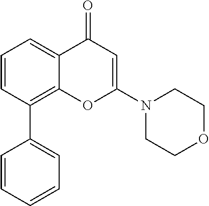 [SMILES: O=c1cc(N2CCOCC2)oc2c(-c3ccccc3)cccc12]

Quercetin is a natural flavonoid found abundantly in vegetables and fruits that inhibits Pim-1 As such, in certain embodiments of the present invention, Quercetin acts as a CT reducing agent. In various embodiments, it does so by inhibiting the activity of the Pim1 gene product. Quercetin has the following chemical structure:

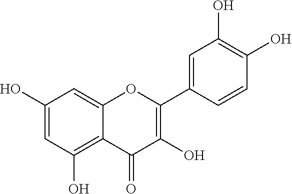 [SMILES: O=c1c(O)c(-c2ccc(O)c(O)c2)oc2cc(O)cc(O)c12]

Adenosine monophosphate, also known as 5′-adenylic acid and abbreviated AMP, is a nucleotide that is found in RNA that inhibits Pim-1. As such, in certain embodiments of the present invention, Adenosine monophosphate acts as a CT reducing agent. In various embodiments, it does so by inhibiting the activity of the Pim1 gene product. Adenosine monophosphate has the following chemical structure:

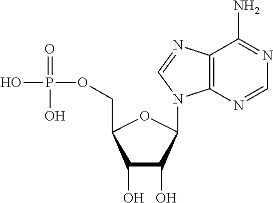

Working Example:

The following working example is included to provide an example of one embodiment of the present invention, and is not meant to limit these disclosures in any way.

Afatinib Reduces CT Related Death in Mammalian Embryonic Stem Cells

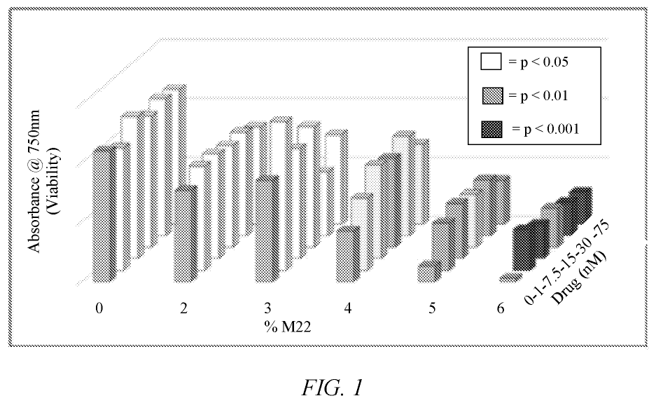

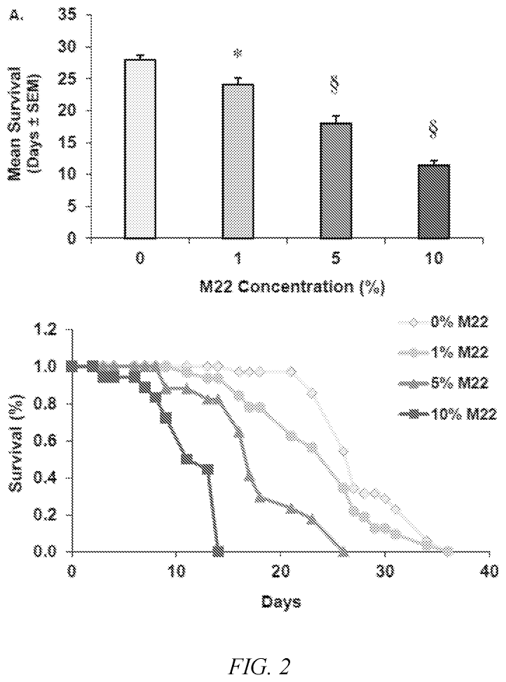

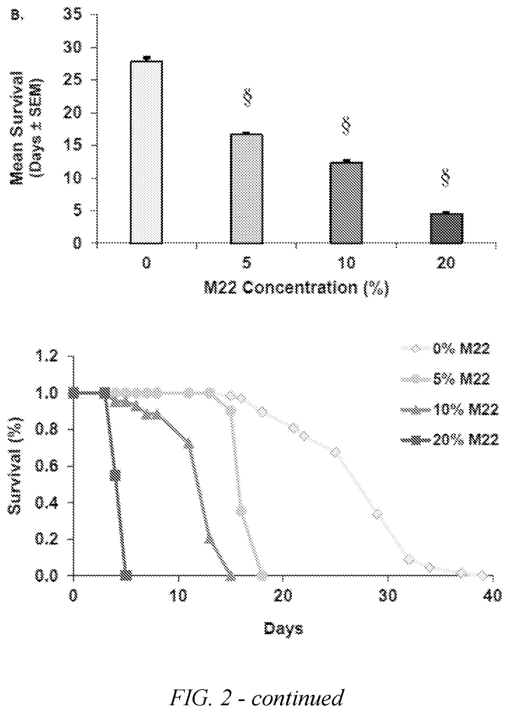

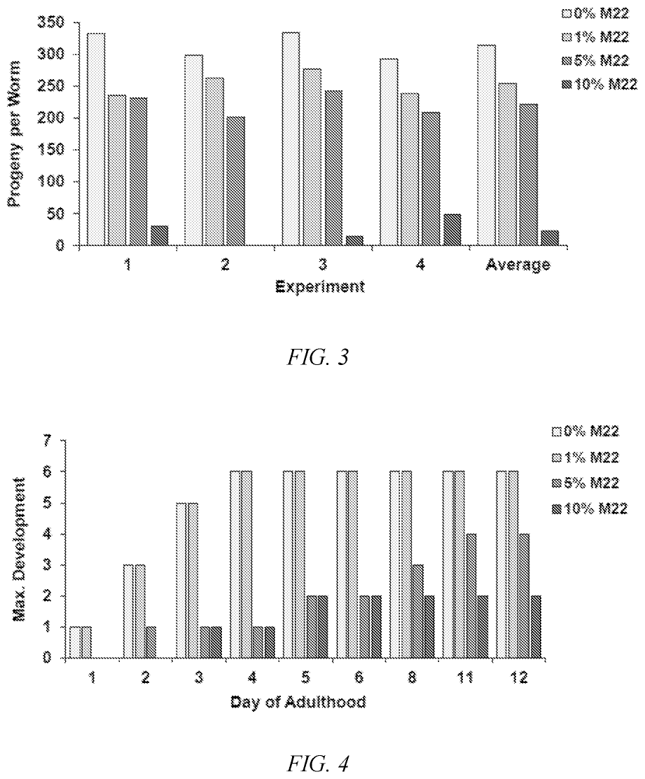

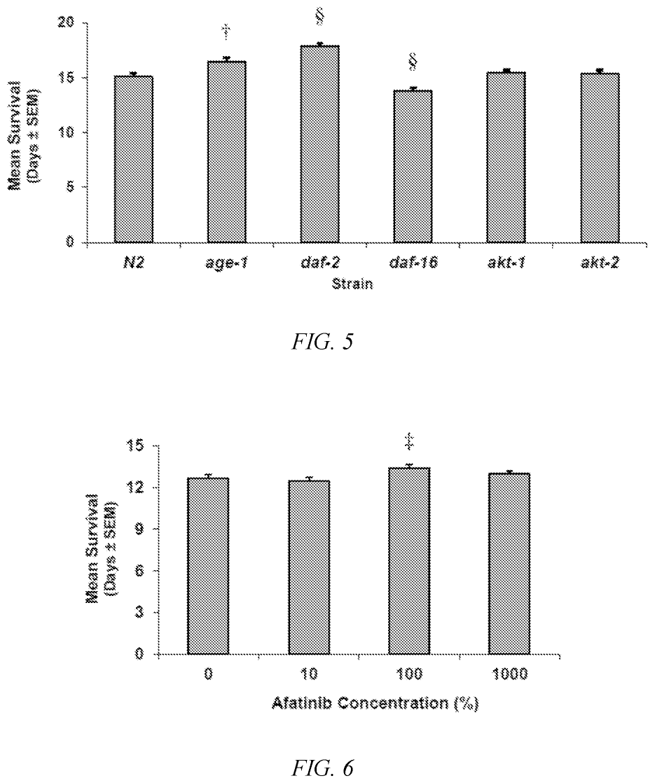

Mouse embryonic stem cells (ESCs) were pre-treated with Afatinib in concentrations of 1 nM, 7.5 nM, 15 nM, 30 nM, and 75 nM. The ESCs were then subjected to various concentrations of M22, including a lethal challenge of 6% in normal culture media. As shown in FIG. 1, ESCs treated with even small amounts of Afatinib showed increased resistance to M22 toxicity at lower M22 concentrations, and even survived an otherwise lethal M22 challenge. These results clearly demonstrate the CT reducing ability of the FDA approved drug Afatinib.

### EXAMPLE 2

### Mutant Resistance to 10% M22 in Liquid

Fertile young adult worms were put into liquid survival medium with 10% M22 and followed until death. A wild-type control, N2, and mutants from the ILS pathway were compared. Shown are date of experiment, p value compared to N2, day worms were put into M22, number of worms, mean survival, SEM and mean of each strain divided by the N2 mean. All experiments were blinded. Results are presented in Table 2, below.

### EXAMPLE 3

### Mutant Resistance to 10% M22 in Liquid

Young adult worms from TJ1060 were grown on agar plates at 25° C. with varying concentrations of Afatinib and put into liquid survival medium with 10% M22+/−Afatinib at 20° C. They were followed until all were dead. Data from 4 replicate experiments are shown; experiments were blinded. Results are presented in Table 3, below.

### EXAMPLE 4

### Survival on Afatinib on Agar Plates

Eggs from TJ1060 were put onto NGM agar plates with varying concentrations of Afatinib at 25° C. On day 3, sterile staged young adult worms were moved to agar plates with Afatinib at 20° C. and followed until all were dead. Results are presented in Table 4, below.

Six cryo-selected clones have been generated. Two of these contain insertions near genes associated with potential drugs.

Clone M2.2: one of two flanking genes (Nrg2) normally promotes growth via direct interaction with a receptor tyrosine kinase (ERB3/4). The drug Afatinib acts as a permanent inhibitor of ERB3/4. Reduced expression/function of Nrg2 and the drug Afatinib may thus each act to downregulate ERB3/4. Afatinib may be available for about $50/10 mg and has an IC50 of about 1 nanomolar.

Clone 3.1: one of two flanking genes (Pim1) may be inhibited by as many as 23 candidate compounds. At least five of these are available at reasonable cost (see table). Two compounds that are of particular interest: (1) Quercetagetin and (2) Staurosporine. Quercetagetin may function to protect boreal tree cells from extreme cold, possibly involved in ice nucleation. Quercetagetin and/or Staurosporine have not been previously reported to act through Pim1.

CPA Toxicity data in C. elegans (worms) has been collected and is presented herein. Some important items to note are: (1) Afatinib protects worms in 10% M22 at a concentration of 100 nm (not 0, 10 or 1000 nm), and Afatinib did not have a longevity effect, indicating that the NRG2 pathway is highly associated with CPA Toxicity just as in mouse embryonic stem cells. (2) Mutant worms (mutations in insulin-like pathway genes) modulate CPA toxicity differently. Daf-2 and age-1 mutants are more resistant to 10% M22 and daf-16 is more sensitive compared to WT worms. With respect to the mutant mouse embryonic stem cell data, the mutants are more sensitive to high-level exposures of M22 (60 and 90% M22). This is an important finding because: (1) Most mutational events negatively affect organisms, so the fact that we have mutants that are resistant to low-level M22 exposures (1-10% M22) is astounding. (2) The same mutants are not resistant to greater exposures, so the mutations are only beneficial in low-level M22 exposures. (3) Given the same pB mutant selection system, beneficial mutations to clinically-relevant levels of CPA exposure (60-100% M22) can be found based upon the selection criteria employed.

Numerous chemical structures are disclosed herein. The compounds of the present invention also include any derivative compounds with a similar biological activity. It is within the skill of the art to make derivative structures of the disclosed chemical compounds using the disclosures of the present application and those that are incorporated by reference. Such derivative compounds include, but are not limited to, substitutions, additions, analogs, and chimeric variants.

Compositions for cryopreserving a biological material are provided herein comprising at least one cryopreservation toxicity (CT) reducing agent and at least one cryopreservation agent.

Kits for cryopreserving a biological material are provided herein comprising an CT reducing agent for cryopreserving a biological material as reported herein. The CT reducing agent and a further cryopreservation agent, if present, may be in the same composition or in separation compositions. Additionally, they may be co-packaged for common presentation or packaged individually. Instructions can also be provided in the kit for cryopreservation of various types of biological material. The kits provided herein can further comprise a cell medium. Examples of suitable cell medium include Eagle's Minimum Essential Medium (MEM), Dulbecco's Modified Eagle's Medium (DMEM), Roswell Park Memorial Institute medium (RPMI), Fetal Bovine Serum (FBS), Fetal Calf Serum (FCS), Ham's F-10, Ham's F-12, Hank's buffered salt solution (HBSS), HBSS and dextrose, and Medium 199 and a combination thereof.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

### Glossary of Claim Terms

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents, and other references mentioned herein are incorporated by reference in their entirety. In case of conflict, the present specification including definitions will control.

The cryopreservation process refers to the preparation, freezing, storage, and thawing of the material to be cryopreserved.

“Vitrification” refers to the chilling of a liquid into an “arrested liquid” or “glass” state, rather than a crystal. A glass is a liquid that is too cold to flow, or a liquid in molecular stasis.

As used throughout the entire application, the terms “a” and “an” are used in the sense that they mean “at least one”, “at least a first”, “one or more” or “a plurality” of the referenced components or steps, unless the context clearly dictates otherwise. For example, the term “a cell” includes a plurality of cells, including mixtures thereof.

The term “and/or” wherever used herein includes the meaning of “and”, “or” and “all or any other combination of the elements connected by said term”.

The term “about” or “approximately” as used herein means within 20%, preferably within 10%, and more preferably within 5% of a given value or range.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

As used herein, the term “comprising” is intended to mean that the products, compositions and methods include the referenced components or steps, but not excluding others. “Consisting essentially of” when used to define products, compositions and methods, shall mean excluding other components or steps of any essential significance. Thus, a composition consisting essentially of the recited components would not exclude trace contaminants and pharmaceutically acceptable carriers. “Consisting of” shall mean excluding more than trace elements of other components or steps.

The term “biological material” refers to any substance which can or has to be removed from a human or non-human, such as an animal, body that is suitable for cryopreservation, such as, but not limited to, organs, tissues, cells, sperm, eggs and embryos. Examples of cells include, but are not limited to, a cell line, a stem cell, a progenitor cell, a liver cell and a red blood cell.

The term “cell medium” refers to a liquid or gel designed to support the growth of microorganisms or cells, such as, but not limited to, Eagle's Minimum. Essential Medium (MEM), Dulbecco's Modified Eagle's Medium (DMEM), Roswell Park Memorial Institute medium (RPMI) Fetal Bovine Serum (FBS), Fetal Calf Serum (FCS), Ham's F-10, Ham's F-12, Hank's buffered salt solution (HBSS), HBSS and dextrose, and Medium 199.

The term “cryopreservation agent” refers to a compound which assists in the cryopreservation of a biological material. Examples of suitable cryopreservation agents include, but are not limited to, DMSO, glycerol, and other biopolymers used in cryopreservation. Examples of suitable biopolymers include, but are not limited to, polyvinyl alcohol.

The phrase “selecting at least one of a group consisting of X and Y” refers to situations where X is selected alone, Y is selected alone, and where both X and Y are selected together.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

All references cited in the present application are incorporated in their entirety herein by reference to the extent not inconsistent herewith.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

TABLE 2
Mutant resistance to 10% M22 in liquid

| Strain | date | p vs N2 | resistance | M22 day | E | Mean | SEM | strain/N2 |
|---|---|---|---|---|---|---|---|---|
| N2 | Feb. 27, 2017 | | control | 4 | 43 | 15.1 | 0.2 | |
| | May 22, 2017 | | control | 5 | 67 | 18.4 | 0.5 | |
| | Jul. 10, 2017 | | control | 3 | 38 | 11.1 | 0.6 | |
| | Sep. 19, 2017 | | control | 4 | 41 | 13.4 | 0.6 | |
| | summary | | control | | 189 | 15.1 | 0.3 | |
| TJ1052 age-1 | Feb. 27, 2017 | 0.514 | ns | 4 | 35 | 15.1 | 0.3 | 1.0 |
| (hx546) | May 22, 2017 | 0.003 | more | 5 | 64 | 20.6 | 0.3 | 1.1 |
| | Jul. 10, 2017 | 0.050 | more | 3 | 38 | 13.2 | 0.5 | 1.2 |
| | Sep. 19, 2017 | 0.116 | ns | 4 | 50 | 14.7 | 0.5 | 1.1 |
| | summary | 0.007 | more | | 187 | 16.5 | 0.3 | 1.1 |
| CB1370 daf-2 | Feb. 27, 2017 | 0.065 | ns | 4 | 43 | 15.9 | 0.1 | 1.0 |
| (e1370) | Jul. 10, 2017 | 0.000 | more | 3 | 45 | 20.5 | 0.5 | 1.8 |
| | Sep. 19, 2017 | 0.000 | more | 4 | 40 | 17 | 0.5 | 1.3 |
| | summary | 0.000 | more | | 128 | 17.9 | 0.3 | 1.2 |
| GR1307 daf-16 | May 22, 2017 | 0.000 | less | 5 | 77 | 15.6 | 0.3 | 0.8 |
| (mgDf50) | Jul. 10, 2017 | 0.038 | less | 3 | 39 | 10.9 | 0.5 | 1.0 |
| | Sep. 19, 2017 | 0.227 | ns | 4 | 35 | 13.1 | 0.5 | 1.0 |
| | summary | 0.000 | less | | 151 | 13.8 | 0.3 | 0.9 |
| BQ1 akt-1 | Feb. 27, 2017 | 0.000 | less | 4 | 40 | 13.2 | 0.5 | 0.9 |
| (mg306) | May 22, 2017 | 0.220 | ns | 5 | 58 | 18.1 | 0.4 | 1.0 |
| | Jul. 10, 2017 | 0.016 | more | 3 | 32 | 13.9 | 0.5 | 1.3 |
| | Sep. 19, 2017 | 0.185 | ns | 4 | 45 | 15 | 0.4 | 1.1 |
| | summary | 0.557 | ns | | 175 | 15.4 | 0.3 | 1.0 |
| VC204 akt-2 | Feb. 27, 2017 | 0.493 | ns | 4 | 37 | 14.8 | 0.4 | 1.0 |
| (ok393) | May 22, 2017 | 0.799 | ns | 5 | 47 | 18.1 | 0.4 | 1.0 |
| | Jul. 10, 2017 | 0.005 | more | 3 | 46 | 13.3 | 0.7 | 1.2 |
| | Sep. 19, 2017 | 0.242 | ns | 4 | 39 | 14.3 | 0.7 | 1.1 |
| | summary | 0.810 | ns | | 169 | 15.4 | 0.3 | 1.0 |

TABLE 3
Worms on 10% M22 +/− Afatinib in liquid

| Strain | date | % M22 | Afatinib | p value | resistance | M22 day | E | Mean | SEM |
|---|---|---|---|---|---|---|---|---|---|
| TJ1060 | Oct. 23, 2017 | 10% | none | control | | 3 | 46 | 10.2 | 0.2 |

| | | | | | | | | |
|---|---|---|---|---|---|---|---|---|
| 10% | 10 | nM | 0.084 | ns | 3 | 38 | 10.4 | 0.3 |
| 10% | 100 | nM | 0.000 | more | 3 | 46 | 11.3 | 0.4 |
| 10% | 1000 | nM | 0.234 | ns | 3 | 45 | 10.3 | 0.3 |

| | | | | | | | | |
|---|---|---|---|---|---|---|---|---|
| TJ1060 | Nov. 11, 2017 | 10% | none | control | 3 | 39 | 12.9 | 0.4 |

| | | | | | | | | |
|---|---|---|---|---|---|---|---|---|
| 10% | 10 | nM | 0.556 | ns | 3 | 36 | 12.4 | 0.5 |
| 10% | 100 | nM | 0.032 | more | 3 | 44 | 13.5 | 0.5 |
| 10% | 1000 | nM | 0.764 | ns | 3 | 41 | 13.2 | 0.4 |

| | | | | | | | | |
|---|---|---|---|---|---|---|---|---|
| TJ1060 | Nov. 28, 2017 | 10% | none | control | 3 | 51 | 13.4 | 0.3 |

| | | | | | | | | |
|---|---|---|---|---|---|---|---|---|
| 10% | 10 | nM | 0.014 | less | 3 | 41 | 12.3 | 0.4 |
| 10% | 100 | nM | 0.169 | ns | 3 | 54 | 13.2 | 0.5 |
| 10% | 1000 | nM | 0.460 | ns | 3 | 52 | 13.0 | 0.4 |

| | | | | | | | | |
|---|---|---|---|---|---|---|---|---|
| TJ1060 | Feb. 13, 2018 | 10% | none | control | 3 | 37 | 14.6 | 0.4 |

| | | | | | | | | |
|---|---|---|---|---|---|---|---|---|
| 10% | 10 | nM | 0.341 | ns | 3 | 45 | 14.6 | 0.4 |
| 10% | 100 | nM | 0.027 | more | 3 | 49 | 15.3 | 0.3 |
| 10% | 1000 | nM | 0.016 | more | 3 | 42 | 15.6 | 0.3 |

| | | | | | | | |
|---|---|---|---|---|---|---|---|
| TJ1060 | summary | 10% | none | control | 173 | 12.7 | 0.2 |

| | | | | | | | |
|---|---|---|---|---|---|---|---|
| 10% | 10 | nM | 0.932 | ns | 160 | 12.5 | 0.2 |
| 10% | 100 | nM | 0.000 | more | 193 | 13.4 | 0.2 |
| 10% | 1000 | nM | 0.115 | ns | 180 | 13.0 | 0.2 |

TABLE 4
Survival on Afatinib on agar plates

| Strain | date | Afatinib | | p value | survival | N | Mean | SEM |
|---|---|---|---|---|---|---|---|---|
| TJ1060 | Apr. 4, | none | | control | | 17 | 19.9 | 1.2 |
| | 2017 | 10 | nM | 0.151 | ns | 36 | 22.1 | 0.6 |
| | | 20 | nM | 0.515 | ns | 29 | 21.1 | 0.7 |
| | | 100 | nM | 0.291 | ns | 14 | 21.8 | 2.1 |
| | | 1000 | nM | 0.998 | ns | 30 | 20.0 | 0.7 |
| TJ1060 | May 23, | none | | control | | 46 | 22.8 | 0.9 |
| | 2017 | 10 | nM | 0.028 | less | 39 | 20.5 | 0.7 |
| | | 100 | nM | 0.014 | less | 32 | 19.4 | 0.9 |
| | | 1000 | nM | 0.098 | ns | 37 | 20.8 | 0.9 |
| TJ1060 | Nov. 1, | none | | control | | 27 | 17.6 | 1.0 |
| | 2017 | 10 | nM | 0.208 | ns | 37 | 19.7 | 0.6 |
| | | 100 | nM | 0.019 | more | 34 | 21.1 | 0.9 |
| | | 1000 | nM | 0.008 | more | 43 | 21.7 | 0.8 |
| TJ1060 | Feb. 13, | none | | control | | 32 | 21.0 | 0.9 |
| | 2018 | 10 | nM | 0.009 | less | 36 | 19.1 | 0.6 |
| | | 100 | nM | 0.037 | less | 25 | 19.8 | 1.0 |
| | | 1000 | nM | 0.000 | less | 34 | 19.4 | 0.7 |

| | | | | | | |
|---|---|---|---|---|---|---|
| TJ1060 | summary | none | control | 122 | 20.8 | 0.5 |

| | | | | | | |
|---|---|---|---|---|---|---|
| 10 | nM | 0.075 | ns | 148 | 20.3 | 0.3 |
| 100 | nM | 0.355 | ns | 105 | 20.4 | 0.5 |
| 1000 | nM | 0.009 | less | 144 | 20.6 | 0.4 |

TABLE 5
Cryo Drug Summary.

| | GENES | | | DRUG |
|---|---|---|---|---|
| | IN/NEAR | POTENTIAL | DRUG | APPROVED |
| CLONE | INSERT | DRUGS | STATUS | FOR |
| M2.2 | Nrg2 | Afatinib/Gilotrif | Approved | NSC Lung Cancer |
| M2.2 | Pura | None found | | |
| M3.1 | Fgd2 | None found | | |
| M3.1 | Pim1 | Quercetagetin | ? | |
| M3.1 | Pim1 | LY294002 | ? | |
| M3.1 | Pim1 | Quercetin | experimental | |
| M3.1 | Pim1 | Adenosine | approved | |
| | | monophosphate | nutriceutical | |
| | | (Adenosine 5 - | | |
| | | monophosphate | | |
| | | monohydrate) | | |
| M3.1 | Pim1 | Staurosporine | experimental | |
| M3.1 | Pim1 | 3,4-Dihydroxy-1- | experimental | |
| | | Methylquinolin- | | |
| | | 2(1h)-One | | |
| M3.1 | Pim1 | 2-(4-Morpholinyl)-8- | experimental | |
| | | Phenyl-4h-1- | | |
| | | Benzopyran-4-One | | |
| M3.1 | Pim1 | (3e)-3-[(4- | experimental | |
| | | Hydroxyphenyl)Imino]- | | |
| | | 1h-Indol-2(3h)-One | | |
| M3.1 | Pim1 | Rbt205 Inhibitor | experimental | |
| M3.1 | Pim1 | Phosphoaminophosphonic | experimental | |
| | | Acid-Adenylate Ester | | |
| M3.1 | Pim1 | Phosphonoserine | experimental | |
| M3.1 | Pim1 | S,S-(2-Hydroxyethyl) | experimental | |
| | | Thiocysteine | | |
| M3.1 | Pim1 | IMIDAZOPYRIDAZIN 1 | experimental | |
| M3.1 | Pim1 | 4-(4-hydroxy-3- | experimental | |
| | | methylphenyl)-6- | | |
| | | phenylpyrimidin- | | |
| | | 2(5H)-one | | |
| M3.1 | Pim1 | N-phenyl-1H- | experimental | |
| | | pyrrolo[2,3- | | |
| | | b]pyridin-3-amine | | |
| M3.1 | Pim1 | (2S)-1,3- | experimental | |
| | | benzothiazol-2-yl{2- | | |
| | | [(2-pyridin-3-ylethyl) | | |
| | | amino]pyrimidin- | | |
| | | 4-yl} ethanenitrile | | |
| M3.1 | Pim1 | (4R)-7,8-dichloro- | experimental | |
| | | 1′,9-dimethyl-1-oxo-1,2,4,9- | | |
| | | tetrahydrospiro[beta- | | |
| | | carboline-3,4′- | | |
| | | piperidine]-4-carbonitrile | | |
| M3.1 | Pim1 | (4R)-7-chloro-9- | experimental | |
| | | methyl-1-oxo-1,2,4,9- | | |
| | | tetrahydrospiro[beta- | | |
| | | carboline-3,4′- | | |
| | | piperidine]-4-carbonitrile | | |
| M3.1 | Pim1 | 5,7-DIHYDROXY- | experimental | |
| | | 2-(3,4,5- | | |
| | | TRIHYDROXYPHENYL)-4H- | | |
| | | CHROMEN-4-ONE | | |
| M3.1 | Pim1 | 6-(5-BROMO-2- | experimental | |
| | | HYDROXYPHENYL)-2-OXO-4- | | |
| | | PHENYL-1,2- | | |
| | | DIHYDROPYRIDINE-3- | | |
| | | CARBONITRILE | | |
| M3.1 | Pim1 | 4-[3-(4- | experimental | |
| | | chlorophenyl)-2,1- | | |
| | | benzisoxazol-5-yl] | | |
| | | pyrimidin-2-amine | | |
| M3.1 | Pim1 | N-cyclohexyl-3-[3- | experimental | |
| | | (trifluoromethyl)phenyl] | | |
| | | [1,2,4]triazolo[4,3-b] | | |
| | | pyridazin-6-amine | | |
| M3.1 | Pim1 | 2,3-diphenyl-1H- | experimental | |
| | | indole-7-carboxylic acid | | |

| | | | |
|---|---|---|---|
| M4.3 | Myh9 | Blebbistatin | Blebbistatin inhibits the MYH9 |
| | | | protein - Chiu et al., Molecular |
| | | | Oncology 6 , 2012) 299-310. |
| M5.1 | Hsbp1 | Agalloside | Agalloside inhibits the HSBP1 |
| | | | protein - Arai et al., Chem. Sci., |
| | | | 2016, 7, 1514-1520. |

TABLE 6
Cryo Drug Cost.

| | | | IC50 | | | |
|---|---|---|---|---|---|---|
| | | DRUG | DOSE | | DRUG | DRUG |
| POTENTIAL | DRUG | APPROVED | (NANO | DRUG | MASS | COST/ |
| DRUGS | STATUS | FOR | MOLARITY) | COST | (MG) | UNIT |
| AFATINIB/ | Approved | NSC Lung | 1 | $50 | 10 | $5.00 |
| GILOTRIF | | Cancer | | | | |
| NONE FOUND | | | | | | |
| NONE FOUND | | | | | | |
| QUERCETAGETIN | ? | | 340 | $279 | | |
| LY294002 | ? | | 500 | $154 | 5000 | $0.06 |
| QUERCETIN | experimental | | | $22 | 5 | $30.80 |
| ADENOSINE | approved | | | $41.40 | 50000 | $0.00 |
| MONOPHOSPHATE | nutriceutical | | | | | |
| (ADENOSINE 5 - | | | | | | |
| MONOPHOSPHATE | | | | | | |
| MONOHYDRATE) | | | | | | |
| STAUROSPORINE | experimental | | | $150 | 5000 | $0.01 |
| 3,4-DIHYDROXY-1- | experimental | | | | 10 | $15.00 |
| METHYLQUINOLI | | | | | | |
| N-2(1H)-ONE | | | | | | |

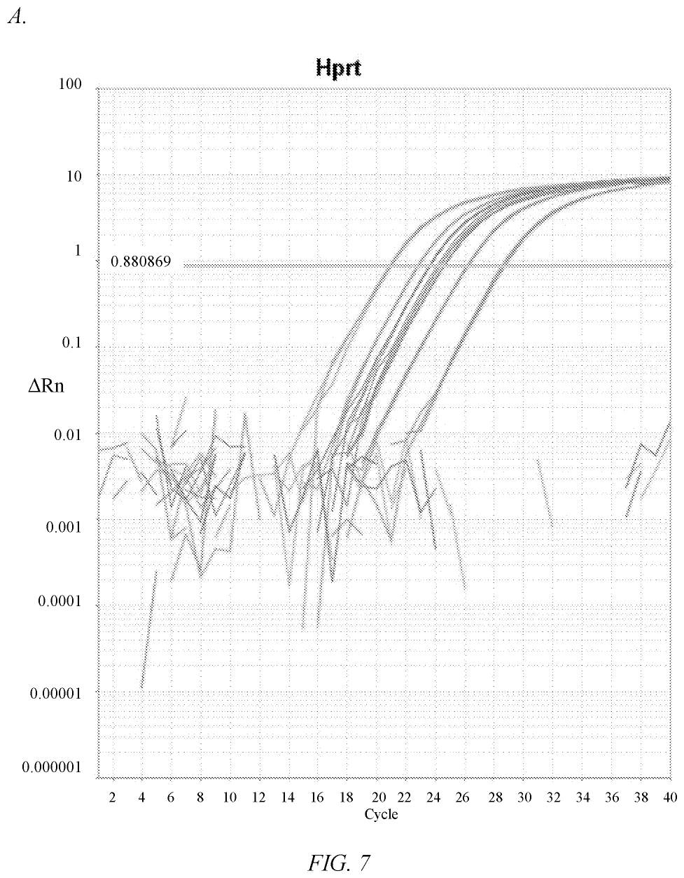

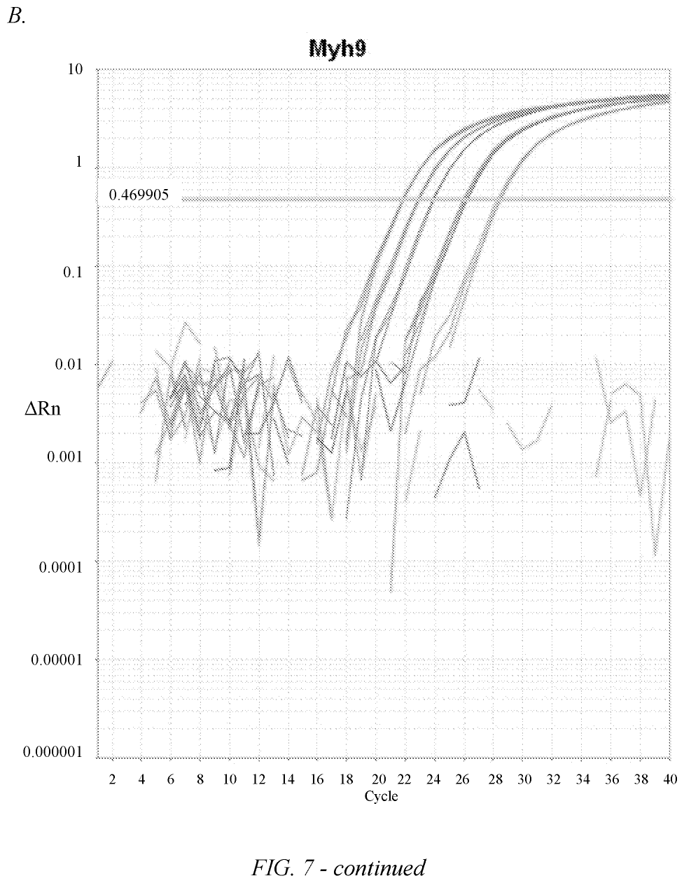

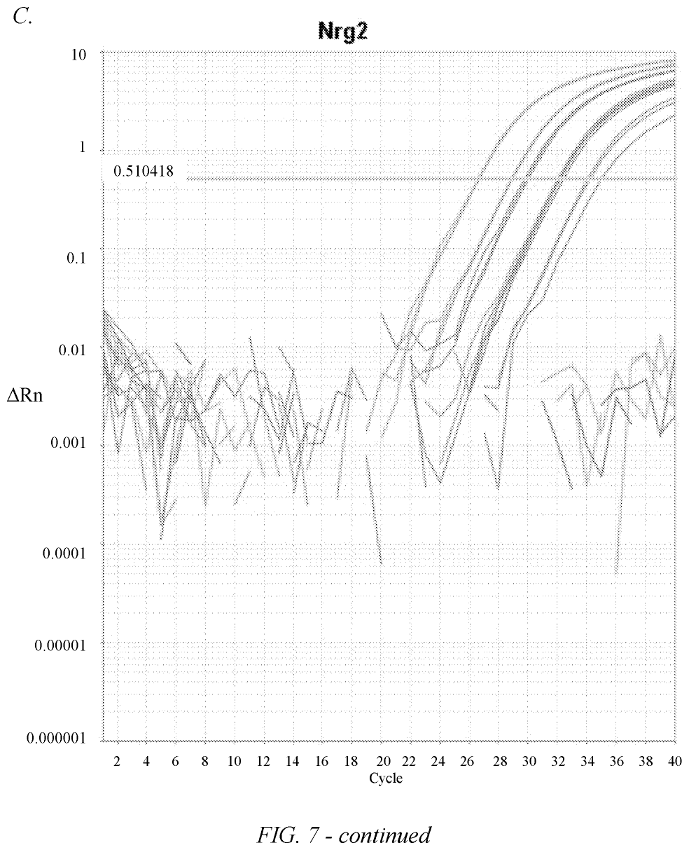

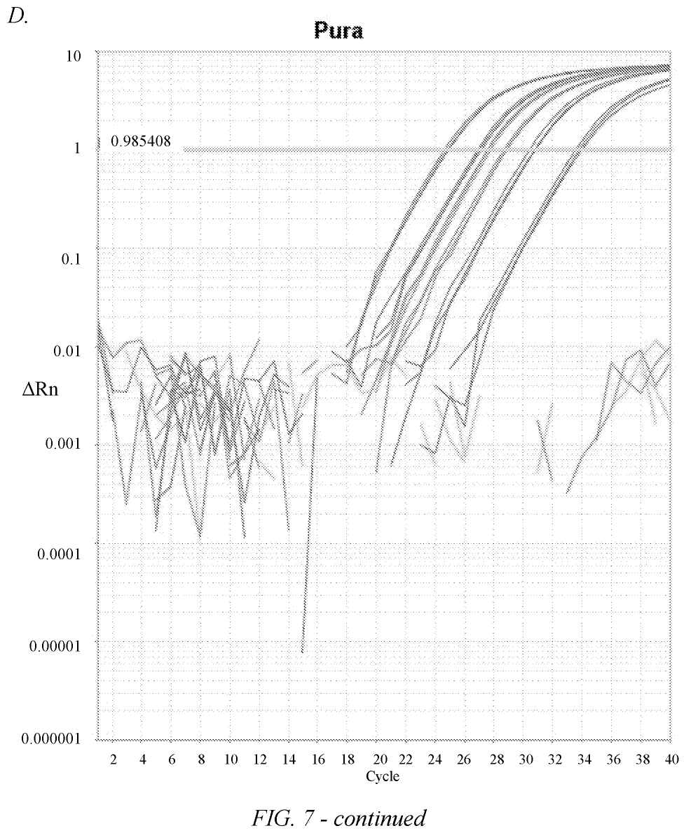

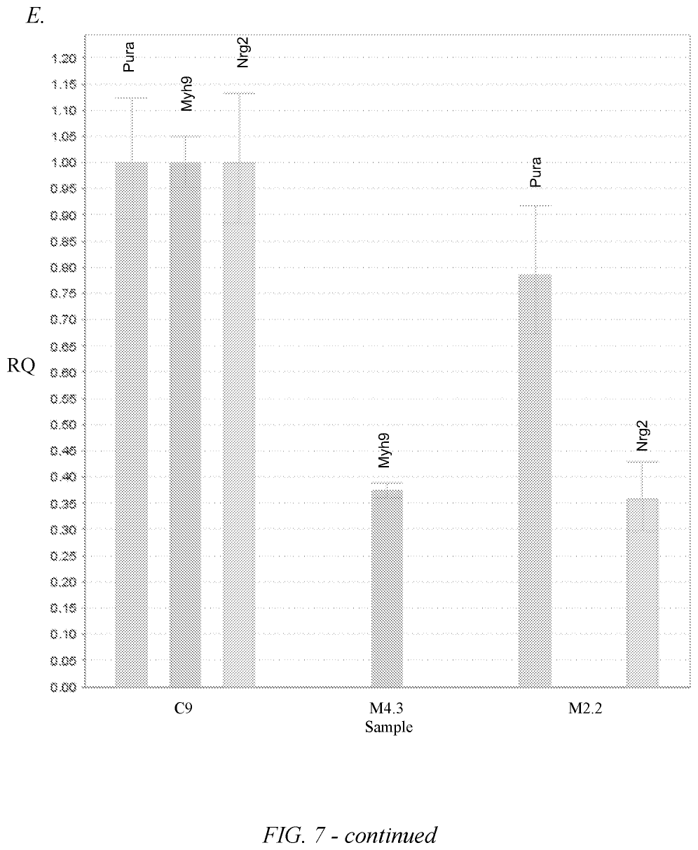

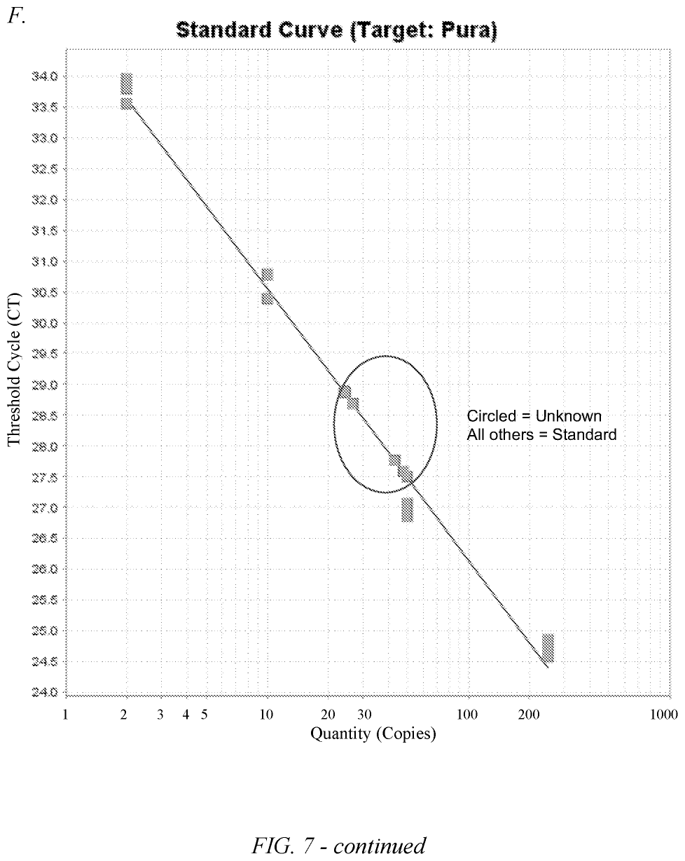

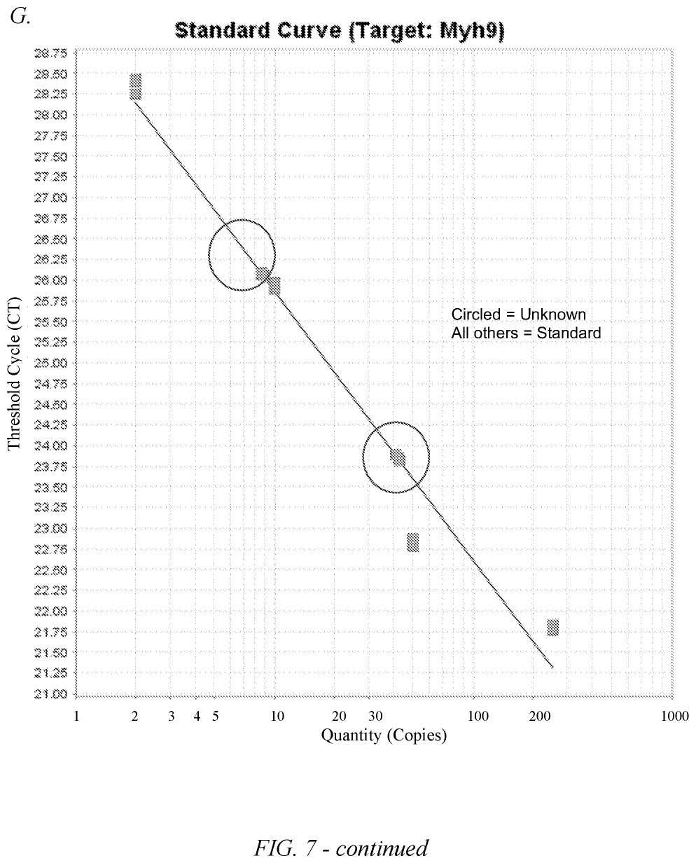

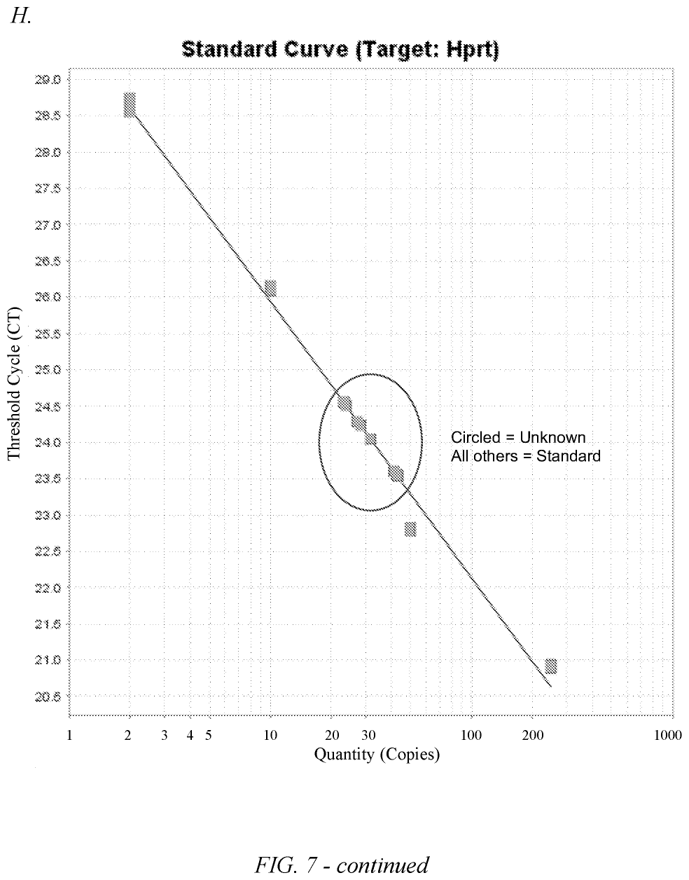

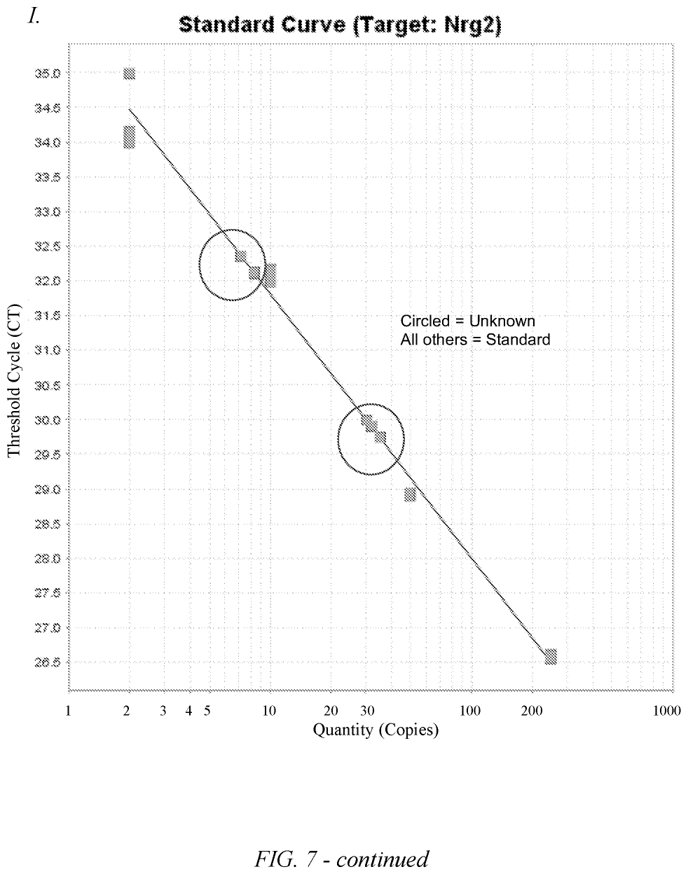

TABLE 7
Results Summary for FIG. 7 - (n mutant M2.2,
expression of the gene Nrg2 is downregulated.

| | | | | Normalized | Normalized | | | |
|---|---|---|---|---|---|---|---|---|
| | | C | C | Qty | Qty | | RQ | RQ |
| Sample | Target | (Mean) | (Std Dev) | (Mean) | (Std Err) | RQ | (Min) | (Max) |
| C9 * | Hprt † | 23.5622 | | | | | | |
| M2.2 | Hprt † | 24.192 | | | | | | |
| M4.3 | Hprt † | 24.5314 | | | | | | |
| C9 * | Myh9 | 23.8537 | 0.0332 | 0.983 | 1.0174 | 1 | 0.9532 | 1.0491 |
| M2.2 | Myh9 | | | | | | | |
| M4.3 | Myh9 | 26.0757 | 0.0213 | 0.3677 | 1.0132 | 0.374 | 0.3607 | 0.3879 |
| C9 * | Nrg2 | 29.8734 | 0.1232 | 0.767 | 1.0455 | 1 | 0.8839 | 1.1314 |
| M2.2 | Nrg2 | 32.1964 | 0.1385 | 0.2746 | 1.0672 | 0.358 | 0.2989 | 0.4289 |
| M4.3 | Nrg2 | | | | | | | |
| C9 * | Pura | 27.6197 | 0.1339 | 1.1017 | 1.0427 | 1 | 0.8904 | 1.1231 |
| M2.2 | Pura | 28.8106 | 0.1141 | 0.866 | 1.0569 | 0.7861 | 0.6741 | 0.9166 |
| M4.3 | Pura | | | | | | | |

What is claimed is:

1. A method for reducing cryopreservation toxicity (CT) in living cells, the method comprising:
identifying cells at risk of CT; and
administering to said cells an effective amount of a CT reducing agent.

2. The method of claim 1 wherein said cells at risk of CT are aggregated into a tissue.

3. The method of claim 2 wherein said tissue is an organ comprised of at least one cell type.

4. The method of claim 1 where said CT reducing agent is selected from the group consisting of Afatinib, Staurosporine, and UCN-01.

5. The method of claim 1 where said CT reducing agent is selected from the group consisting of Afatinib, Gilotrif, Staurosporine, UCN-01, Quercetagetin, LY294002, Quercetin, Adenosine monophosphate, Blebbistatin, and Agalloside.

6. The method of claim 5 comprising administering a combination of two or more of the CT reducing agents.

7. The method of claim 1 where said CT reducing agent is selected from the group consisting of Afatinib, Gilotrif, Quercetagetin, LY294002, Quercetin, Adenosine monophosphate (Adenosine 5-monophosphate monohydrate), Staurosporine, 3,4-Dihydroxy-1-Methylquinolin-2(1h)-One, 2-(4-Morpholinyl)-8-Phenyl-4h-1-Benzopyran-4-One, (3e)-3-[(4-Hydroxyphenyl)Imino]-1h-Indol-2(3h)-One, Rbt205 Inhibitor, Phosphoaminophosphonic Acid-Adenylate Ester, Phosphonoserine, S, S-(2-Hydroxyethyl)Thiocysteine, IMIDAZOPYRIDAZIN 1,4-(4-hydroxy-3-methylphenyl)-6-phenylpyrimidin-2(5H)-one, N-phenyl-1H-pyrrolo[2,3-b]pyridin-3-amine, (2S)-1,3-benzothiazol-2-yl{2-[(2-pyridin-3-ylethyl)amino]pyrimidin-4-yl}ethanenitrile, (4R)-7,8-dichloro-1′,9-dimethyl-1-oxo-1,2,4,9-tetrahydrospiro[beta-carboline-3,4′-piperidine]-4-carbonitrile, (4R)-7-chloro-9-methyl-1-oxo-1,2,4,9-tetrahydrospiro[beta-carboline-3,4′-piperidine]-4-carbonitrile, 5,7-DIHYDROXY-2-(3,4,5-TRIHYDROXYPHENYL)-4H-CHROMEN-4-ONE, 6-(5-BROMO-2-HYDROXYPHENYL)-2-OXO-4-PHENYL-1,2-DIHYDROPYRIDINE-3-CARBONITRILE, 4-[3-(4-chlorophenyl)-2,1-benzisoxazol-5-yl]pyrimidin-2-amine, N-cyclohexyl-3-[3-(trifluoromethyl)phenyl][1,2,4]triazolo[4,3-b]pyridazin-6-amine, 2,3-diphenyl-1H-indole-7-carboxylic acid, Blebbistatin, and Agalloside.

8. The method of claim 7 comprising administering a combination of two or more of the CT reducing agents.

9. The method of claim 1 wherein said CT reducing agent is administered prior to the cryopreservation of the cells.

10. The method of claim 1 wherein said CT reducing agent is administered during the cryopreservation process.

11. The method of claim 1 wherein said CT reducing agent is administered after the cells have underwent the cryopreservation process.

12. The method of claim 1 where said CT reducing agent is Afatinib.

13. The method of claim 12 wherein the concentration of Afatinib is between more than 10 nm and less than 1,000 nm.

14. The method of claim 12 wherein the concentration of Afatinib is between about 50 nm and about 500 nm.

15. The method of claim 12 wherein the concentration of Afatinib is about 100 nm.

16. A method for reducing cryopreservation toxicity (CT) in a cell, the method comprising:
providing a cell or cells for cryopreservation; and
administering to said cell or cells an effective amount of a CT reducing agent selected from the group consisting of Afatinib, Gilotrif, Staurosporine, UCN-01, Quercetagetin, LY294002, Quercetin, Adenosine monophosphate, Blebbistatin, and Agalloside.

17. The method of claim 16 comprising administering a combination of two or more of the CT reducing agents.

18. The method of claim 16 wherein said CT reducing agent is administered prior to the cryopreservation of the cells.

19. The method of claim 16 wherein said CT reducing agent is administered during the cryopreservation process.

20. The method of claim 16 wherein said CT reducing agent is administered after the cells have underwent the cryopreservation process.

21. The method of claim 16 where said CT reducing agent is Afatinib.

22. The method of claim 21 wherein the concentration of Afatinib is between more than 10 nm and less than 1,000 nm.

23. The method of claim 21 wherein the concentration of Afatinib is between about 50 nm and about 500 nm.

24. The method of claim 21 wherein the concentration of Afatinib is about 100 nm.

25. A method for reducing cryopreservation toxicity (CT) in a cell comprising:
providing a cell or cells for cryopreservation;
contacting said cell or cells with an effective amount of the CT reducing agent Afatinib; and
cooling said cell or cells to a cryogenic temperature.

26. The method of claim 25 wherein the concentration of Afatinib is between more than 10 nm and less than 1,000 nm.

27. The method of claim 25 wherein the concentration of Afatinib is between about 50 nm and about 500 nm.

28. The method of claim 25 wherein the concentration of Afatinib is about 100 nm.
